(19) United States
(12) Patent Application Publication
(10) Pub. No.: US 2013/0141790 A1
(43) Pub. Date: Jun. 6, 2013

(54) DIFFRACTIVE OPTICAL ELEMENT AND IMAGING APPARATUS USING THE SAME

(71) Applicant: PANASONIC CORPORATION, Osaka (JP)

(72) Inventors: Yoshiyuki SHIMIZU, Osaka (JP); Tetsuya SUZUKI, Osaka (JP); Toshiaki TAKANO, Osaka (JP); Koji FUJII, Osaka (JP)

(73) Assignee: PANASONIC CORPORATION, Osaka (JP)

(21) Appl. No.: 13/756,093

(22) Filed: Jan. 31, 2013

Related U.S. Application Data
(63) Continuation of application No. PCT/JP2011/006801, filed on Dec. 5, 2011.

(30) Foreign Application Priority Data
Feb. 22, 2011 (JP) 2011-035667

(51) Int. Cl. G02B 5/18

(52) U.S. Cl. CPC G02B 5/18
USPC 359/569

(57) ABSTRACT

It is an objective of the present disclosure to prevent or reduce cracks in edge portions of raised portions of a diffractive optical element.

A diffractive optical element includes a diffractive surface. The diffractive surface includes a plurality of raised portions. Each of the raised portion has a first surface having a diffraction function, and a second surface extending upright to be connected to the first surface. A tilt angle of the second surface relative to an optical axis varies according to a region in the diffractive surface.

### CROSS-REFERENCE TO RELATED APPLICATION

This is a continuation of PCT International Application PCT/JP2011/006801 filed on Dec. 5, 2011, which claims priority to Japanese Patent Application No. 2011-035667 filed on Feb. 22, 2011. The disclosures of these applications including the specifications, the drawings, and the claims are hereby incorporated by reference in their entirety.

### BACKGROUND

The present disclosure relates to a diffractive optical element having at least one optical surface formed as a diffractive surface and an imaging apparatus including the diffractive optical element.

Conventionally, a diffractive optical element having a diffractive surface has been known (see Japanese Patent Publication No. H9-127321). For example, a diffractive optical element of Japanese Patent Publication No. H9-127321 is configured so that several optical members are stacked on each other and a boundary surface between the optical members is formed as a diffractive surface. The diffractive surface is formed by a diffractive grating having a serrated cross-sectional shape. Specifically, the diffractive surface at one of the optical members includes a plurality of raised portions each having a chevron shape, and as a whole has a shape in which raised and recessed portion are alternately repeated. The raised portion has a first wall tilted to an optical axis and having a diffraction function, and a second wall formed upright in an optical axis direction and connected to the first wall. The diffractive surface at the other of the optical members has an inverted shape relative to the shape of the diffractive surface at the one of the optical members.

### SUMMARY

In forming a diffractive optical element having the above-described diffractive surface, a molding technique such as press molding, etc. is used. However, in the conventional refractive optical element, cracks might occur at ridge portions of the raised portions or valley bottoms of the recessed portions of a serrated shape. For example, in a cooling step in molding of the diffractive optical element, the amount of contraction of the diffractive optical element is larger in an outer region than in a central region. Thus, the raised portions of the diffractive optical element receive greater restriction from a metal die in the outer region of the diffractive optical element. As a result, cracks might occur in the outer region of the diffractive optical element. Even in other cases, cracks might occur in the diffractive optical element for various reasons, and the occurrence of cracks might vary according to a location in the diffractive surface.

In view of the foregoing, a technique disclosed therein has been devised to prevent or reduce cracks formed in a diffractive optical element.

A diffractive optical element includes a diffractive surface. The diffractive surface includes a plurality of raised portions. Each of the raised portion has a first surface having a diffraction function, and a second surface extending upright to be connected to the first surface. A tilt angle of the second surface relative to an optical axis varies according to a region in the diffractive surface.

According to the foregoing diffractive optical element, since the tilt angle of the second surface of the raised portion varies according to a region in the diffractive surface, cracks of the diffractive optical element can be prevented or reduced.

### BRIEF DESCRIPTION OF THE DRAWINGS

FIG. 1 is a schematic cross-sectional view of a diffractive optical element according to a first embodiment.

FIG. 2 is a view schematically illustrating respective steps for producing a diffractive optical element according to the first embodiment. FIG. A illustrates a state in which a glass material is set on a molding die, and FIG. B illustrates a state in which the glass material is pressed by the molding die.

FIG. 3 is a schematic cross-sectional view of a diffractive optical element according to a second embodiment.

FIG. 4 is a schematic cross-sectional view of a diffractive optical element according to a third embodiment.

FIG. 5 is a schematic cross-sectional view of a diffractive optical element according to a fourth embodiment.

FIG. 6 is a view schematically illustrating respective steps for producing a diffractive optical element according to the fourth embodiment. FIG. A illustrates a state in which a resin material is set on a molding die, FIG. B illustrates a state in which the resin material is pressed by a first optical member and the molding die, and FIG. C illustrates a state in which the diffractive optical element is removed from the molding die.

FIG. 7 is a schematic cross-sectional view of a diffractive optical element according to a fifth embodiment.

FIG. 8 is a schematic cross-sectional view of an imaging apparatus according to a sixth embodiment.

### DETAILED DESCRIPTION

Example embodiments will be described in detail below with reference to the accompanying drawings.

### First Embodiment

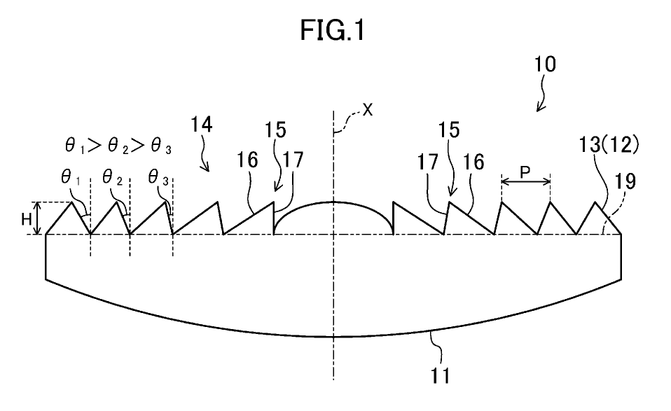

FIG. 1 is a schematic cross-sectional view of a diffractive optical element 10 according to this embodiment.

The diffractive optical element 10 is formed of an optical member which is optically transparent. The diffractive optical element 10 includes a first optical surface 11 and a second optical surface 12 which are opposed to each other. The second optical surface 12 is formed as a diffractive surface 13. That is, at least one optical surface (the second optical surface 12) of the diffractive optical element 10 is formed as the diffractive surface 13. The diffractive optical element 10 may be made of an optical material such as a glass material, or a resin material, etc. Note that the first optical surface 11 may be a spherical or an aspherical surface.

As the diffractive surface 13, a diffractive grating 14 is formed. The diffractive grating 14 includes a plurality of raised portions 15. The raised portions 15 are formed on a base surface 19. The base surface 19 may be a flat surface. The base surface 19 is defined by a plane passing through lower edges of the raised portions 15. Each of the raised portions 15 extends in a circumferential direction around an optical axis X of the diffractive optical element 10, and the raised portions 15 are regularly arranged in a concentric pattern around the optical axis X. A lateral cross section (a cross section perpendicular to a direction in which the raised portions 15 extend) of each of the raised portions 15 may have a substantially triangular shape. More specifically, each of the raised portions 15 may have a first surface 16 which is tilted relative to the optical axis X and has a diffraction function, and a second surface 17 extending upright from the base surface 19 and connected to the first surface 16. In each of the raised portions 15, the first surface 16 is at the outer side in a radial direction around the optical axis X, whereas the second surface 17 is at the inner side in the radiation direction. A connection part of the first surface 16 and the second surface 17 forms a ridge portion.

In this embodiment, the height (which will be also referred to as “lattice height”) H of the raised portions 15 is substantially uniform throughout the diffractive optical element 10. The height of the raised portion 15 herein means a distance from the base surface 19 to a top (a ridge portion) of each raised portion 15 in an optical axis X direction. The pitch P of the raised portions 15 is smaller in an outer region of the diffractive optical element 10 located outside a central region thereof including the optical axis X than in the central region. Specifically, the pitch P reduces as a distance from the optical axis X in the radial direction increases. The pitch P of the raised portions 15 herein means a distance between adjacent ones of the tops of the raised portions 15 in the radial direction around the optical axis X. For example, the height H of the raised portions 15 is 5-20 μm. The pitch P of the raised portions 15 is 400-2000 μm in the central region A, and is 100-400 μ in the outer region. These values can be appropriately set according to optical properties required for the diffractive optical element.

The first surface 16 is a tilted surface which is tilted relative to the optical axis X, and has the diffraction function. A tilt angle of the first surface 16 of each of the raised portions 15 is appropriately set so that the diffractive surface 13 as a whole can have the desired diffraction function.

The second surface 17 extends substantially in parallel to the optical axis X, and is connected to a tip end (a farther end from the base surface 19) of the first surface 16. The second surface 17 may be tilted relative to the optical axis X in part or entirety of the diffractive surface 13. A tilt angle of the second surface 17 relative to the optical axis X may vary according to a location in the diffractive surface 13. That is, the tilt angle θ (hereinafter simply referred to as a “tilt angle”) of the second surface 17 relative to the optical axis X varies according to a region in the diffractive surface 13. Specifically, the tilt angle θ of the second surface 17 is different between the central region and the outer region. For example, in the central region, the second surface 17 extends parallel to the optical axis X, and the tilt angle θ of the second surface 17 is 0. On the other hand, in the outer region, the second surface 17 is tilted to the outer side in the radial direction as a distance from the base surface 19 to the second surface 17 increases. That is, the tilt angle θ of the second surface 17 in the outer region is larger than that in the central region.

More specifically, the tilt angle θ of the second surface 17 increases from the central region to the outer region (i.e., from the inner side to the outer side in the radial direction). As illustrated in, e.g., FIG. 1, a relationship θ₁>θ₂>θ₃ is satisfied, where the tilt angle of the second surface 17 of the outermost raised portion 15 is θ₁, the tilt angle of the second surface 17 of the second outermost raised portion 15 is θ₂, and the tilt angle of the second surface 17 of the third outermost raised portion 15 is θ₃. The tilt angle θ of the second surface 17 in the central region is preferably 0°-10°, and the tilt angle θ of the second surface 17 in the outer region is preferably 10°-30°.

[Production Method]

Next, a method for producing a diffractive optical element 10 according to this embodiment will be described.

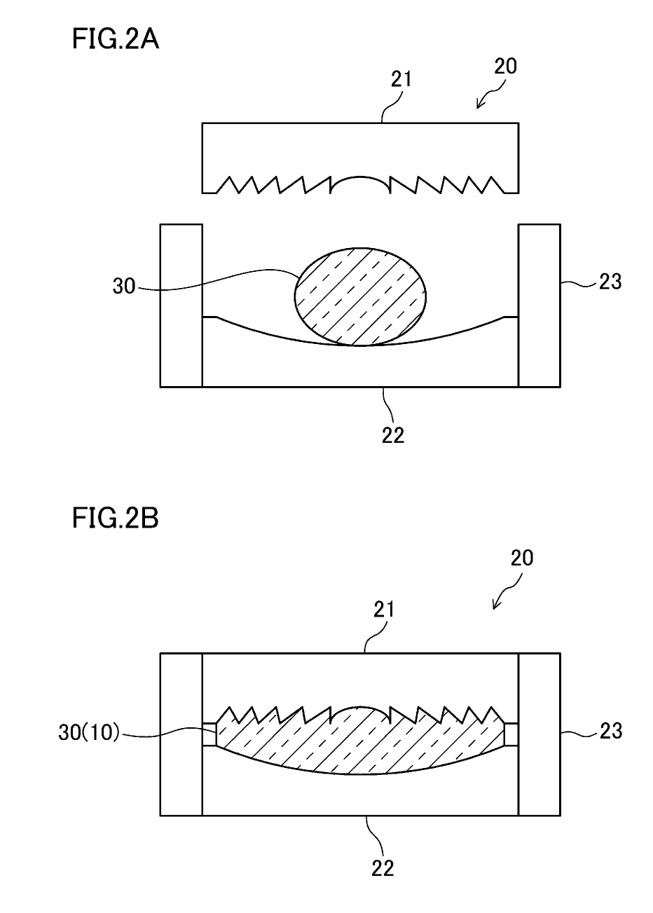

First, as shown in FIG. 2A, a molding die 20 (an upper die 21, a lower die 22, and a body die 23) is prepared. An inverted shape relative to the shape of the diffractive surface 13 is formed in a molding surface of the upper die 21. A molding surface of the lower die 22 is a spherical surface or an aspherical surface. A glass material 30 is placed on the molding surface of the lower die 22. Next, as shown in FIG. 2B, the upper die 21 is moved down toward the lower die 22 along the body die 23, thereby pressing the glass material 30. Process conditions such as a molding temperature and a molding time, etc. are set appropriately.

When the pressing is completed, the upper die 21 is moved upward to remove the glass material 30. The glass material 30 is cooled down for a predetermined time, thereby obtaining the diffractive optical element 10.

Since the diffractive optical element 10 of this embodiment is formed such that the tilt angle θ of the second surface 17 varies according to a region in the diffractive surface 13, the tilt angle θ in a region where cracks are likely to occur can be relatively increased. Specifically, in a cooling step of press molding, the diffractive optical element 10 is contracted. Since the diffractive optical element 10 is in such a shape that the dimension of the diffractive optical element 10 in the radial direction is larger than that in the optical axis X direction, displacement of each of the raised portions 15 is greater in the radial direction than in the optical axis X direction upon the contraction of the diffractive optical element 10. At this time, since the raised portions 15 of the diffractive optical element 10 are engaged with raised portions of the upper die 21, movement of the raised portions 15 in the radial direction is restricted by the raised portions of the upper die 21. Thus, force acts on the raised portions 15 outward in the radial direction of the diffractive optical element 10. Since the strength in the ridge portion (i.e., a tip end portion) of the raised portion 15 is low, cracks are likely to occur. In addition, stress is likely to be concentrated at valley bottoms each formed by adjacent ones of the raised portions 15, and thus, cracks are likely to occur at these portions. The amount of contraction is larger in the outer region than in the central region of the diffractive optical element 10. Thus, cracks are more likely to occur at the foregoing portions in the outer region of the diffractive optical element 10. In this embodiment, the tilt angle θ of the second surface 17 is larger in the outer region than in the central region. The second surface 17 tilted to the optical axis X allows force from the raised portions of the upper die 21 toward the outer side in the radial direction to be dispersed in the optical axis direction. Thus, cracks of the raised portions 15 of the diffractive optical element 10 can be prevented or reduced. Further, the force dispersed in the optical axis direction advantageously acts as force by which the diffractive optical element 10 and the upper die 21 are separated from each other.

Since the amount of contraction is generally larger in the outer region than in the central region, cracks of the raised portions 15 are more likely to occur in the outer region. However, the region where cracks of the raised portions 15 are likely to occur is not only the outer region. Depending on molding conditions or the shape of the diffractive optical element 10, there is an exception in which the tendency that cracks are more likely to occur in the outer region is not exhibited. In such an exception, the tilt angle θ of the second surface 17 of the raised portion 15 in a region where cracks are likely to occur is set so as to be larger than that in other region. As a result, cracks of the raised portions 15 in the region where cracks are likely to occur can be prevented or reduced.

### Second Embodiment

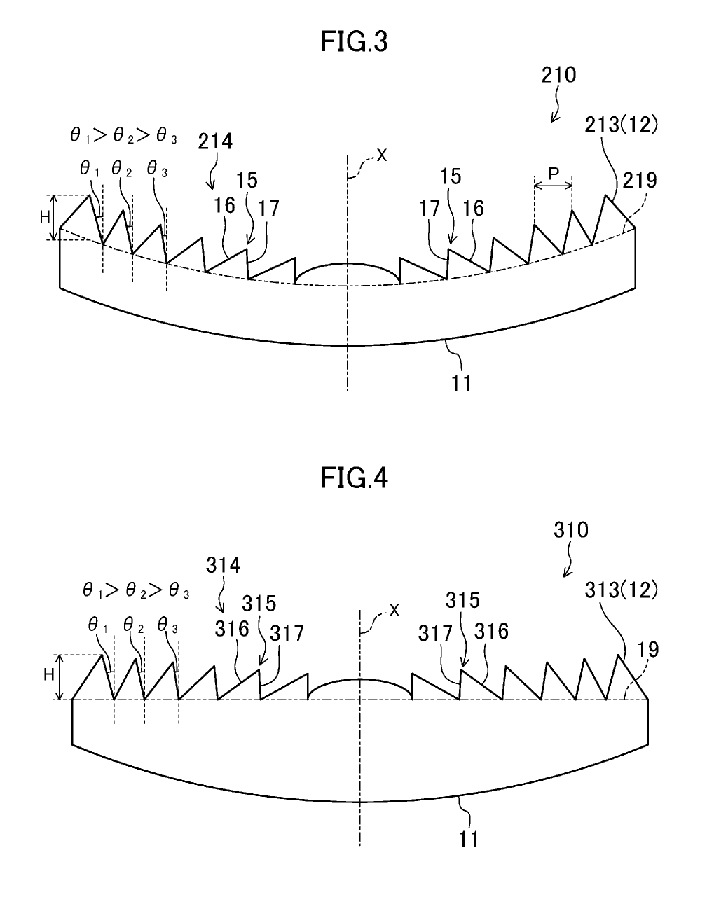

Next, a diffractive optical element 210 according to a second embodiment will be described with reference to the accompanying drawings. FIG. 3 is a schematic cross-sectional view of the diffractive optical element 210.

The diffractive optical element 210 of this embodiment is different from the diffractive optical element 10 of the first embodiment in that a base surface is a concave surface. Thus, the diffractive optical element 210 will be described below with focus on the difference from the diffractive optical element 10 of the first embodiment. Each configuration having similar function and shape to those in the first embodiment is given the same reference characters, and the description thereof might not be repeated.

A diffractive surface 213 of the diffractive optical element 210 includes a base surface 219 and a diffractive grating 214 formed on the base surface 219. The base surface 219 is a concave surface, and more specifically may be a spherical or an aspherical surface.

A raised portion 15 of the diffractive grating 214 includes a first surface 16 and a second surface 17. As in the first embodiment, a tilt angle θ of the second surface 17 is larger in an outer region than in a central region of the diffractive optical element 210.

As in the first embodiment, the diffractive optical element 210 is molded by a molding die 20. An inverted shape relative to the shape of the diffractive surface 213 is formed in a molding surface of an upper die 21. That is, the molding surface of the upper die 21 is in such a shape that a plurality of raised portions are arranged on a convexly-curved base surface.

Since the base surface 219 of the diffractive optical element 210 is in a concave shape, the diffractive surface 213 covers the molding surface of the upper die 21 from the outside upon the molding of the diffractive optical element 210. Thus, when the diffractive optical element 210 is contracted in a cooling step, the diffractive optical element 210 is contracted such that the raised portions 15 and the raised portions of the upper die 21 are more tightly engaged with each other. As a result, since greater force acts on the raised portions 15, cracks are likely to occur.

On the other hand, in this embodiment, cracks of the raised portions 15 can be prevented or reduced by tilting the second surfaces 17 of the raised portions 15 as in the first embodiment. This embodiment is similar to the first embodiment in that cracks are likely to occur in the outer region of the diffractive optical element 210 where the amount of contraction of the diffractive optical element 210 is larger. Thus, as in the first embodiment, the tilt angle θ of the second surface 17 increases in the outer region, thereby preventing or reducing cracks of the raised portions 15 in the outer region and easily removing the diffractive optical element 210 from the molding die 20.

### Third Embodiment

Next, a diffractive optical element 310 according to a third embodiment will be described with reference to the accompanying drawings. FIG. 4 is a schematic cross-sectional view of the diffractive optical element 310.

The diffractive optical element 310 of this embodiment is different from the diffractive optical element 10 of the first embodiment in that the height of a raised portion increases from a central region to an outer region of the diffractive optical element 310. Thus, the diffractive optical element 310 will be described below with focus on the difference from the diffractive optical element 10 of the first embodiment. Each configuration having similar function and shape to those in the first embodiment is given the same reference characters, and the description thereof might not be repeated.

A diffractive surface 313 of the diffractive optical element 310 includes a base surface 19 and a diffractive grating 314 formed on the base surface 219. The diffractive grating 314 includes a plurality of raised portions 315. The height of the raised portion 315 is higher in the outer region than in the central region. More specifically, the height of the raised portion 315 increases toward an outer side in a radial direction of the diffractive optical element 310. A tilt angle θ of a second surface 317 in the outer region is larger than that in the central region.

Since a higher height of the raised portion 315 results in lower strength of the raised portion 315, cracks of the raised portions 315 are likely to occur upon, e.g., press molding. However, in this embodiment, the tilt angle θ of the second surface 317 is larger for the higher raised portion 315, thereby preventing or reducing cracks of the raised portions 315.

### Fourth Embodiment

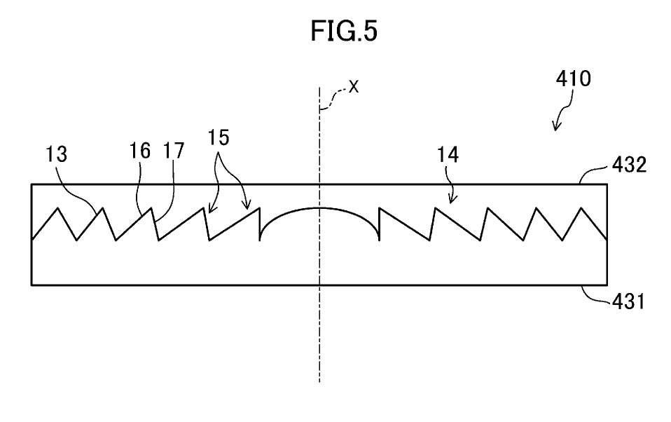

Next, a diffractive optical element 410 according to a fourth embodiment will be described with reference to the accompanying drawings. FIG. 5 is a schematic cross-sectional view of the diffractive optical element 410.

The diffractive optical element 410 of this embodiment is different from the diffractive optical element 10 of the first embodiment in that a plurality of optical members are stacked on each other. Thus, the diffractive optical element 410 will be described below with focus on the difference from the diffractive optical element 10 of the first embodiment. Each configuration having similar function and shape to those in the first embodiment is given the same reference characters, and the description thereof might not be repeated.

As shown in FIG. 5, the diffractive optical element 410 is a close-contact multilayer diffractive optical element in which a first optical member 431 and a second optical member 432 each of which is optically transparent are stacked on each other.

The first optical member 431 and the second optical member 432 are attached to each other. A boundary surface of the first optical member 431 and the second optical member 432 forms a diffractive surface 13. Since the optical power of the diffractive surface 13 has the dependence on wavelength, the diffractive surface 13 gives substantially the same phase difference to lights having different wavelengths to diffract the lights having different wavelengths at different diffraction angles.

In this embodiment, the first optical member 431 is made of a glass material, and the second optical member 432 is made of a resin material. For example, as the resin material, an ultraviolet curable resin or a thermally curable resin can be used.

[Production Method]

A method for producing the diffractive optical element 410 will be described.

First, the first optical member 431 is prepared. The first optical member 431 can be produced in the same manner as in the first embodiment.

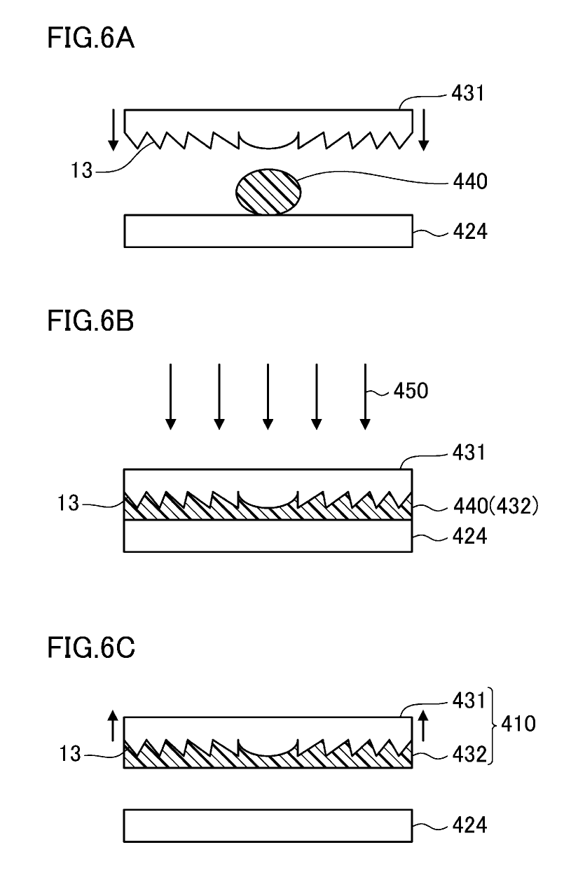

Subsequently, as shown in FIG. 6A, a lower die 424 is prepared. The lower die 424 has a shape corresponding to the shape of a surface of the second optical member 432 which is opposed to the diffractive surface 13. Then, an ultraviolet curable resin material 440 is placed on the lower die 424. Thereafter, the first optical member 431 is moved toward the lower die 424 with the diffractive surface 13 facing toward the lower die 424.

Then, as shown in FIG. 6B, the resin material 440 is pressed by the first optical member 431 and the lower die 424 to deform the resin material 440 into a shape corresponding to the shapes of the first optical member 431 and the lower die 424. Thereafter, the resin material 440 is irradiated with ultraviolet radiation 450. When the resin material 440 has been irradiated with the ultraviolet radiation 450 for a predetermined time, the resin material 440 is hardened, and thus, the second optical member 432 is formed.

Thereafter, as shown in FIG. 6C, the first optical member 431 and the second optical member 432 are removed from the lower die 424, and thus, the diffractive optical element 410 including the first optical member 431 and the second optical member 432 integrated as one can be obtained.

### Fifth Embodiment

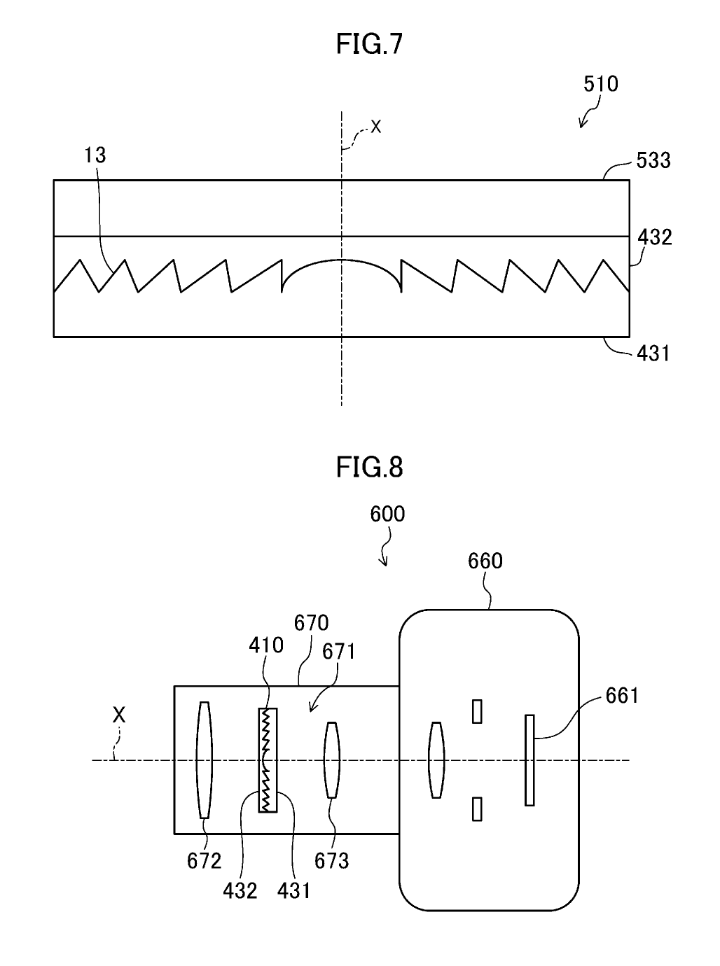

Next, a diffractive optical element 510 according to a fifth embodiment will be described with reference to the accompanying drawings. FIG. 7 is a schematic cross-sectional view of the diffractive optical element 510.

In the diffractive optical element 510, a third optical member 533 is stacked on the second optical member 432 of the diffractive optical element 410 of the fourth embodiment. The third optical member 533 may be made of a glass material or a resin material.

### Sixth Embodiment

Next, a camera 600 according to a sixth embodiment will be described with reference to the accompanying drawings. FIG. 8 is a schematic view of the camera 600.

The camera 600 includes a camera body 660 and an interchangeable lens 670 coupled to the camera body 660. The camera 600 serves as an imaging apparatus.

The camera body 660 includes an imaging device 661.

The interchangeable lens 670 is configured to be removable from the camera body 660. The interchangeable lens 670 is, for example, a telephoto zoom lens. The interchangeable lens 670 has an imaging optical system 671 for focusing a light bundle on the imaging device 661 of the camera body 660. The imaging optical system 671 includes the diffractive optical element 410 and refracting lenses 672 and 673. The diffractive optical element 410 functions as a lens element. The interchangeable lens 670 serves as an optical apparatus.

### Other Embodiments

The above-described embodiments may have the following configurations.

Each of the configurations of the diffractive gratings 14, 214, and 314 described in the above-described embodiments is merely one example, and a diffractive grating according to the present disclosure is not limited to the above-described configuration. For example, each of the raised portions 15 is formed so that a surface thereof at the outer side in the radial direction is the first surface 16 and a surface thereof at the inner side in the radial direction is the second surface 17. However, the raised portions 15 are not limited to such a configuration. That is, each of the raised portions 15 may be configured such that a surface thereof at the outer side in the radial direction is the second surface 17, and a surface thereof at the inner side in the radial direction is the first surface 16. Additionally, the lattice height H and the pitch P of the raised portions 15 are not limited to those described in the above-described embodiments. For example, the lattice height H of the raised portions 15 may be larger in the central region than in the outer region. The pitch P of the raised portions 15 may be smaller in the central region than in the outer region, and alternatively, may be uniform throughout the entire region of the diffractive surface. In the above-described embodiments, the lattice height H and the pitch P gradually varies according to a location in the radial direction. However, the diffractive surface may be divided into a plurality of regions, and the lattice height H or the pitch P may be set to be uniform in the same region and to be different between different regions.

The tilt angle θ of the second surface 17 may be limited to those of the above-described embodiments as long as the tilt angle θ of the second surface 17 varies according to a location in the diffractive surface 13. For example, the tilt angle θ of the second surface 17 may be larger in the central region than in the outer region. Alternatively, the second surface 17 may be configured not such that the tilt angle θ of the second surface 17 gradually varies according to a distance in the radial direction or the height of the raised portion 15, but such that the diffractive surface 13 may be divided into a plurality of regions based on the distance in the radial direction and the height of the raised portion 15 and the tilt angle θ of the second surface 17 may be uniform in the same region and different between different regions.

Note that the tilt angle θ of the second surface 17 preferably increases in a region where cracks of the raised portions 15 is likely to occur. Cracks of the raised portions 15 are more likely to occur toward the outer side in the radial direction, to occur as the height of the raised portion 15 increases, or to occur as the aspect ratio (ratio of the height to the width) of the raised portion 15 increases. That is, the second surface 17 may be configured such that the tilt angle θ of the second surface 17 increases with distance from the center of the diffractive optical element. Alternatively, the second surface 17 may be configured such that the tilt angle θ of the second surface 17 increases as the height of the raised portion 15 increases. As another alternative, the second surface 17 may be configured such that the tilt angle θ of the second surface 17 increases as the aspect ratio of the raised portion 15 increases.

There are other factors resulting in the condition where cracks of the raised portions 15 are likely to occur, except for the foregoing factors. Depending on the molding conditions, there may be the case where cracks of the raised portions 15 are more likely to occur on the inner side in the radial direction. In such a case, the tilt angle θ of the second surface 17 may increase toward the inner side in the radial direction.

In the second embodiment, the configuration in which the base surface 219 is curved in a concave shape, but the present disclosure is not limited to such a configuration. The base surface may be formed in a convex shape. That is, the base surface may be in any shapes such as a flat shape and a curved shape.

Each of the raised portions 15 of the diffractive grating 14 has a triangular lateral cross-sectional shape, but is not limited thereto. In the lateral cross-section, the first surface 16 and the second surface 17 are represented by straight lines, but they may have a shape formed by curved lines. The raised portions 15 may be formed in a rectangular shape or a step-like shape. In such a case, each of the raised portions 15 may have a surface extending substantially perpendicular to the optical axis X and surfaces each extending upright from the base surface substantially in the optical axis X direction. Each of the former surfaces serves as the first surface 16 having the diffractive function, and each of the latter surfaces serves as the second surface 17 extending upright from the base surface.

The present disclosure is not limited to the above embodiments, and may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes and modifications which come within the meaning and range of equivalency of the claims are to be embraced within their scope.

The present disclosure is useful for a diffractive optical element including a diffractive surface and an imaging apparatus including the diffractive optical element.

1. A diffractive optical element, comprising:
a diffractive surface,
wherein the diffractive surface includes a plurality of raised portions,
each of the raised portion has a first surface having a diffraction function, and a second surface extending upright to be connected to the first surface,
a tilt angle of the second surface relative to an optical axis varies according to a region in the diffractive surface, and
the tilt angle of the second surface is larger in a region where a height of the raised portion is higher than in a region where the height of the raised portion is lower.

2. The diffractive optical element of claim 1, wherein
the tilt angle of the second surface is different between a central region and an outer region of the diffractive surface.

3. The diffractive optical element of claim 2, wherein
the tilt angle of the second surface is larger in the outer region than in the central region of the diffractive surface.

4. (canceled)

5. An imaging apparatus, comprising:
the diffractive optical element of claim 1.
